(19) United States
(12) Patent Application Publication
(10) Pub. No.: US 2013/0222412 A1
(43) Pub. Date: Aug. 29, 2013

(54) Individualized Visual Color Matching System and Methods

(71) Applicant: Dolby Laboratories Licensing Corporation, (US)

(72) Inventor: Juan P. Pertierra, Indianapolis, IN (US)

(73) Assignee: DOLBY LABORATORIES LICENSING CORPORATION, San Francisco, CA (US)

(21) Appl. No.: 13/771,469

(22) Filed: Feb. 20, 2013

Related U.S. Application Data
(60) Provisional application No. 61/604,791, filed on Feb. 29, 2012.

(51) Int. Cl. G09G 5/02

(52) U.S. Cl. CPC G09G 5/02
USPC 345/593

(57) ABSTRACT

Methods and systems for individualized color matching are described. The described methods and systems are particularly applied by selecting a point or a parameter on a color matching function (CMF) graph and setting a new value for this point or parameter in order to obtain a desired color preference in a displayed image.

### CROSS REFERENCE TO RELATED APPLICATIONS

This Application claims the benefit of priority to related, co-pending Provisional U.S. Patent Application No. 61/604,791 filed on 29 Feb. 2012 entitled “Individualized Visual Color Matching System and Methods” by Juan P. Pertierra, hereby incorporated by reference in its entirety.

### TECHNICAL FIELD

The present teachings relate to visual color matching in viewable images. In particular, the present teachings relate to systems and methods that permit color matching between two or more electronically generated images based on each human individual's color perception of the two or more images.

### BACKGROUND

The visual color matching capacity of any individual may be characterized by a set of three Color Matching Functions (CMFs), which are roughly generated in correspondence to the red, green and blue receptors in the human eye. Efforts to quantify this parameter in a universally applicable manner have led to the generation of certain industry standards, such as CIE 1931 and CIE 1964. The CIE 1931 standard for example, specifies a single set of CMFs based on experiments performed on a group of individuals. This single set of CMFs is currently used across multiple industries in various color matching applications. Unfortunately, universally adopted standards such as the CIE 1931 that are generated with data from a group of individuals, fail to accurately model the color vision of a specific individual outside of that group.

The limitations in current color matching practice become even more significant in view of evolving display technologies such as those associated with light emitting display (LED) televisions, Organic LED (OLED) monitors, and laser displays, due to the characteristics of the light emitted by these technologies.

To better illustrate this problem, consider a Hollywood movie production house that utilizes a “reference” projector to view movies in a private studio theater before release to the general public. In order to be compatible with the public viewing experience, the reference projector used in the studio theater is typically selected to be a standardized replica of various movie projectors used in various cinema theaters. Images generated by the reference projector and projected upon a viewing screen of the private theater for critical review by a movie director may display certain color characteristics to the movie director. However, the same movie may be viewed on an LED television screen by a color correction technician in an adjacent room. The color characteristics of the images seen by the technician on the LED TV may be noticeably different from that viewed by the director due not only to the difference in color perception between technician and the director but also due to the nature of the display medium. Standardized color matching practice currently in use fails to take into consideration such situations wherein color perceptions vary from person to person and device to device. It is therefore desirable to provide systems and methods that address this issue.

### BRIEF DESCRIPTION OF THE DRAWINGS

FIG. 1 shows a setup for performing color matching between two imaging systems.

FIG. 2 shows a setup for performing color matching between two imaging systems.

FIG. 3 shows an exemplary setup in accordance with the invention for performing color matching between two imaging systems.

FIG. 4 shows an exemplary range of variation in color matching functions.

### DESCRIPTION OF EXAMPLE EMBODIMENTS

The following description and drawings are illustrative of the invention and are not to be construed as limiting the invention. Numerous specific details are described to provide a thorough understanding of the invention. However, in certain instances, well known or conventional details are not described in order to avoid obscuring the description of the invention. References to one or an embodiment in the present disclosure are not necessarily references to the same embodiment.

According to a first aspect of the present disclosure, a method for characterizing an individual's perception of color is disclosed herein. The method includes the steps of providing a color matching function (CMF) graph corresponding to a displayed image; selecting a point or a parameter on the color matching function (CMF) graph; and setting a new value for the point or parameter in order to obtain a desired color preference in the displayed image.

According to a second aspect of the present disclosure, a system for color matching display systems is disclosed herein. The system includes an image generation circuit, a display, and a color matching function (CMF) profile modification control. The display is configured to receive a signal from the image generation circuit and display therefrom an image, while the color matching function (CMF) profile modification control is operable to vary at least one of a point or a parameter on a color matching function (CMF) profile for obtaining a desired color preference in the displayed image.

According to a third aspect of the present disclosure, a computer-readable storage medium has stored therein, instructions for varying a magnitude parameter associated with a color matching function (CMF) graph, wherein the varying the magnitude parameter is directed at generating an image with a desired color characteristic at a first wavelength corresponding to the varied magnitude parameter.

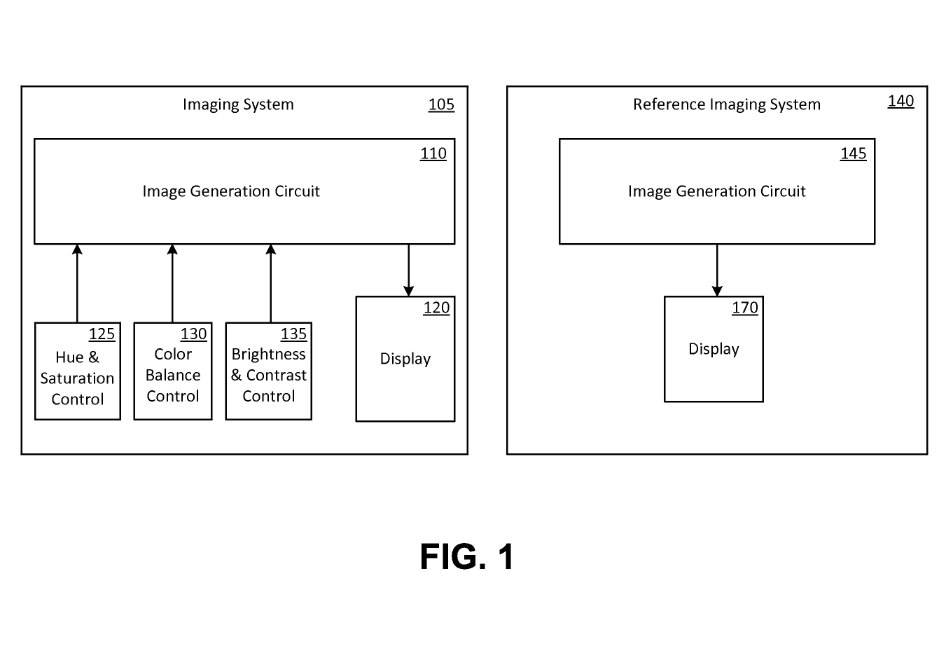

FIG. 1 shows a setup for performing color matching between two imaging systems. Imaging system 105 and reference imaging system 140 include some similar elements. Consequently, it will be understood that some of the description below pertaining to imaging system 105 will be equally applicable to reference imaging system 140 as well.

Imaging system 105 includes a display 120, which is used for viewing images generated by image generation circuit 110 that drives a display 120. Various controls are provided that can be manually operated to control the visual characteristics of images displayed on display 120. Hue and saturation control 125 provides a mechanism by which a human operator can observe an image on display 120 and change the color characteristics of this image to match another image displayed on display 170 of reference imaging system 140. This color changing operation may be carried out by changing the hue (say from a reddish hue to a greenish hue), or a saturation level from a low level to a high level of color, in the image displayed on display 120 so that this image perceptively matches the other image displayed on display 170.

Similarly, color balance control 130 allows the human operator to change the color balance in a viewed image of display 120 so that this image perceptively matches another image displayed on display 170. Brightness and contrast control 135 can be used to set various levels of brightness and/or contrast in the viewed image.

One thing that color balance control 130 shares in common with hue and saturation control 125 is that the color changes impressed upon the viewed image as a result of operating these controls is affected at a macro level. In other words, the resulting changes are not generally of a subtle nature and do not provide a level of granularity that permits one wavelength, or a narrow range of wavelengths, to be modified based on each individual's personal preference.

This disadvantage may be better understood by comparing each of color balance control 130 and saturation control 125 to any one of the base, treble and mid-range controls of an audio amplifier. As can be appreciated, the base, treble and mid-range audio controls provide a coarse level of manual control over relatively large ranges of audio frequencies.

In contrast to the coarse modifications obtained via the base, treble and mid-range controls of an audio amplifier, an audio equalizer system permits a finer granularity of control. The audio equalizer system permits various operations such as for example, allowing a particular high frequency (say one that is causing a hissing sound in the speakers), to be notched out; or allowing the shaping of the mid-range response to correspond to a desired bell curve. As can be understood, the audio characteristics settable via the audio equalizer system more accurately and precisely accommodate personal preferences that vary from one individual to another.

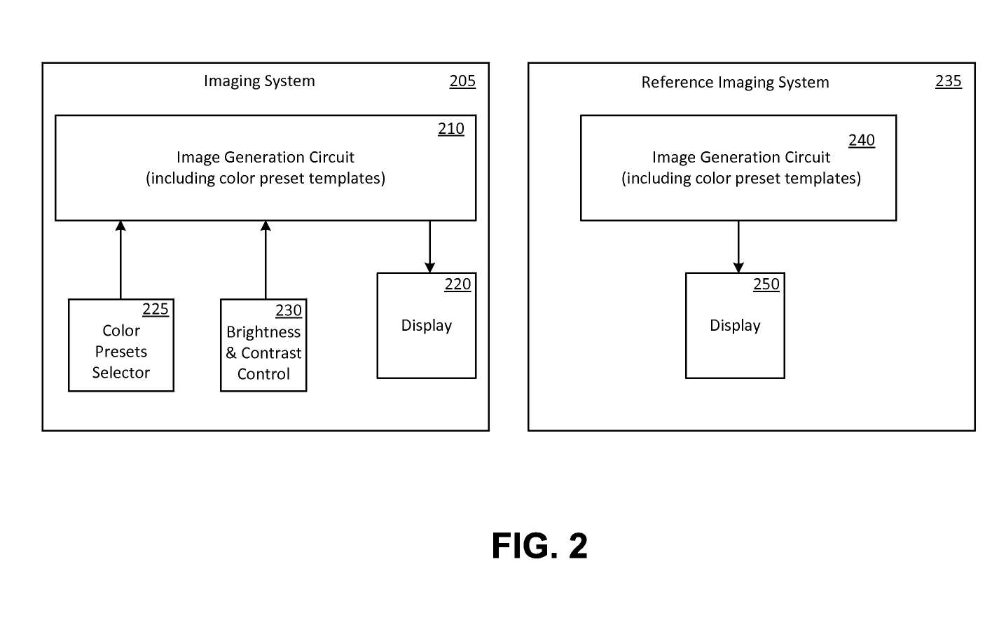

Attention is next drawn to FIG. 2, which shows another setup for performing color matching between two imaging systems. In this setup, a color presets selector 225 is used by a human operator to select one of several color preset templates that may be stored in image generation circuit 210. The presets selection operation may be better understood from a commonly used television color control whereby images viewed on a television screen may be set to have one of a “cool,” “normal,” or “warm” characteristic.

Here again it can be understood that the viewer is not provided with a level of control that accommodates fine variations in color perception from one individual to another. For example, a first viewer may see grass in a viewed image as being light green, while another viewer seeing the very same image may perceive the grass as having an undesirable tinge of blue. Existing controls, such as the “cool,” “normal,” or “warm” image selector control, do not permit color tweaking that would satisfy the individual viewing preferences of the two viewers.

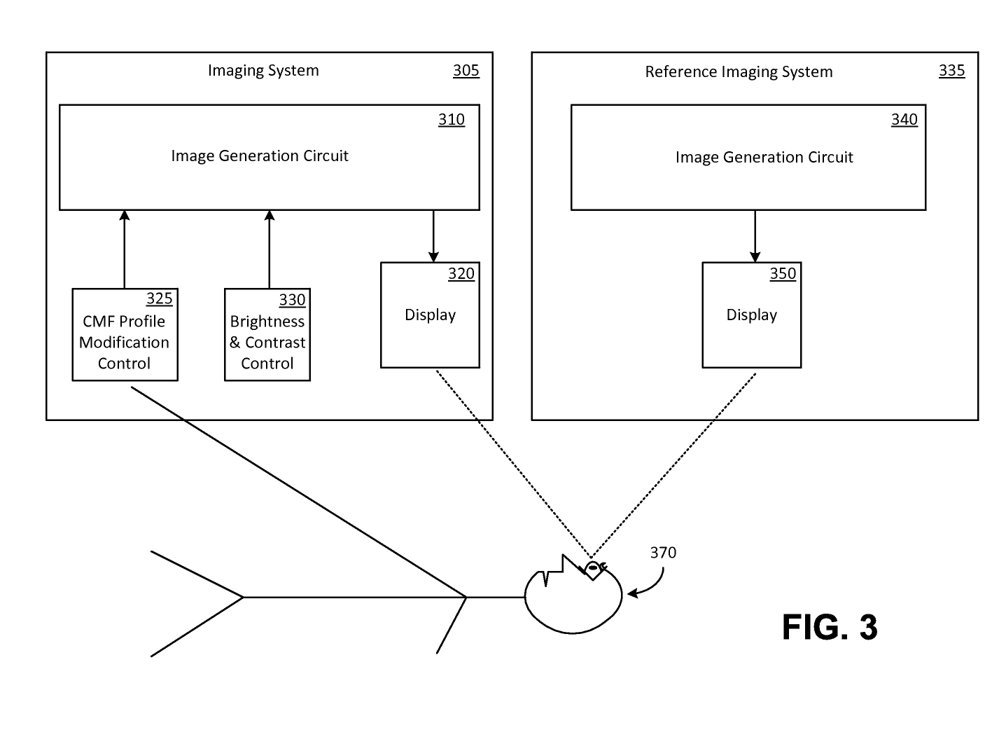

FIG. 3 shows an exemplary setup in accordance with the invention for performing color matching between two imaging systems 305 and 335. While the description below may focus primarily on color matching between images seen on the two different displays 320 and 350, it will be understood that many different variations may be implemented in accordance with the invention.

For example, in a first embodiment, only one of the imaging systems may be independently adjusted in accordance with a viewer's color preference. This may be carried out by using a set of CMFs that have been generated by the same viewer.

In a second embodiment, color adjustments may be carried out by a viewer 370 by comparing an image displayed on display 320 and comparing this image to another image displayed on display 350. The set of CMFs used in this embodiment may be generated by the viewer 370 or may be generated by a source other than viewer 370 (a calibration laboratory or a manufacturer, for example).

In the second embodiment, imaging system 305 and reference imaging system 335 may be placed next to each other, if convenient. However, when inconvenient to do so, imaging system 305 and reference imaging system 335 may be separated from each other and viewer 370 may swivel his/her head to view the two images displayed on the two displays.

Irrespective of the specific embodiments described above, in general, in accordance with the invention, an observer perception profile (in the form of a CMF for example), may be created which quantitatively defines how a particular individual perceives color. This observer profile, together with data gathered from various displays (or other media platforms) may be used to match two arbitrary colors for any particular individual.

Data collected from historical experiments in human vision shows that while there are significant variations in color perception between individuals, there are several characteristics that are shared universally between all individuals with normal color vision. While these shared characteristics may not be adequate for generating individualized color matches for each individual, these shared characteristics may be used in accordance with the invention to provide a set of initial conditions and constraints that can be used to generate an individualized solution.

In one exemplary embodiment, wherein it is desired to provide an individualized match between the color characteristics of an image viewed by viewer 370 on a certain liquid crystal display (LCD) screen (320) and one that is displayed on a plasma screen (350), the first step involves carrying out certain measurements upon both displays in order to obtain spectral information. The next step involves profiling viewer 370 by generating colors on both the LCD and the plasma displays, and asking viewer 370 to adjust CMF profile modification controls 325 and 355 (each implemented for example as a slider image on respective displays 320 and 350, or as a knob on a front panel of respective systems 305 and 335) on the two systems until the colors observed on the LCD and plasma screens are perceptibly identical.

In certain implementations, the CMF profile modification control 325 is selected to provide a limited range of control. This range of control may be based on data obtained from historic color vision experiments. In this particular implementation, CMF profile modification control 325 may be configured to control a limited set of characteristics of a color model that has been shown to vary the most across multiple individuals, while leaving those characteristics that are known to vary a relatively smaller amount unchanged.

Various CMF graphs that are operated upon by CMF profile modification control 325, may be stored, for example as a table in a memory device (not shown) of image generation circuit 310. Image generation circuit 310 may include a processor. In one embodiment, the processor accesses the memory device for retrieving data from one or more of the CMF graphs and uses this data to implement an individualized color matching method in accordance with the invention. In another embodiment, the processor executes a program, which may incorporate a suitable algorithm, in order to dynamically generate one or more CMF graphs. The CMF graphs may be modeled using B-Splines and Stiles functions. Alternatively, the CMF graphs may be modeled in other ways such as by linear or by piecewise scaling.

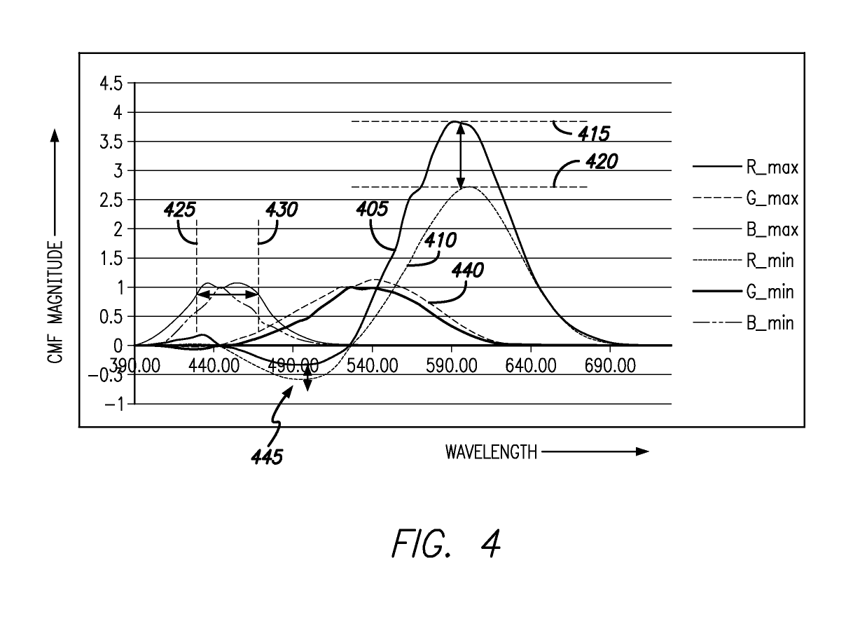

The manner in which these CMF graphs are used will now be described using FIG. 4, which shows three CMF graphs (solid lines) each indicated by a respective peak at one of three primary colors (red, green and blue). A range of values for each of the three CMFs can be recognized by comparing the solid lines to the dashed lines.

For example, attention is drawn to lines 405 and 410 corresponding to a third peak that is approximately centered around 590 nm. Measurement lines (dashed lines 415 and 420) indicate a range of amplitudes that this third peak can encompass. This range (as well as other ranges in the CMF graphs) can be derived in a variety of ways.

In one embodiment, the CMF graphs shown in FIG. 4 are derived by testing conducted on a group of individuals (for example, 52 individuals). Each of the individuals in this group is tested to determine individual CMFs. Thus, for example, one or more individuals may have a set of three CMF graphs (red, green and blue) corresponding to the three solid lines, while another one or more individuals may have another set of three CMFs corresponding to the three dashed lines.

Intermediate values (between the solid and dashed lines) derived from yet other individuals of the group have been omitted, so as to permit FIG. 4 to reflect a range of CMF values rather than each and every CMF value associated with each and every individual.

Attention is now drawn to measurement lines 425 and 430, which indicate a range of magnitude values corresponding to a wavelength approximately centered around 440 nm. While one or more individuals of the tested group may have a peak CMF magnitude a little below 440 nm, one or more other individuals of the tested group may have a peak CMF magnitude a little above 440 nm. In accordance with the invention, the CMF profile modification control 325 described above provides a way for an individual to shift the peak CMF magnitude from a wavelength corresponding to the 425 measurement line to any point up to the 430 measurement line.

In other words, the CMF graphs shown in FIG. 4 provides an indication of the various magnitude and wavelength ranges over which adjustments can be carried out for changing the color characteristics of a displayed image. Thus, viewer 370 may tweak a reddish color component of an image without changing the green or blue characteristics of the image. The viewer 370 may further vary a wavelength in an image, thereby changing a reddish hue to a pinkish hue without affecting the blue and green hues of the image.

In contrast to the peak magnitudes referred to above, various minimum CMF magnitudes, for example in the neighborhood of green wavelengths (510 nm), may also be similarly varied in magnitude and/or wavelength as desired by viewer 370.

It may be pertinent to point out that for any particular individual, there are a large number of spectra that may be different in shape, yet yield the same color perception. Merely because the shape of the spectra is different does not necessarily mean that a particular individual will see different colors. Spectra for which an individual perceives the same color are referred to as metameric pairs. In general, the various methods in accordance with the invention are directed at identifying metameric pairs for an individual given two different spectral sources.

Accordingly, a selected number of points are selected along one or both of the pair of CMFs shown in FIG. 4. Typically, three such points may be selected. This selection process may be described as parameterizing an initial set of CMFs for use in color matching in accordance with the invention.

As can be understood, varying the magnitude of a CMF graph (say by bringing the dashed measurement lines 415 and 420 closer to each other) does not necessarily lead to large changes across multiple wavelengths, but does permit a fine level of color control upon selected wavelengths.

The changes in the magnitude, or wavelength, carried out by using CMF profile modification control 325 for example, are recognized by software that is executed in order to suitably drive light source 315 for generating one or more images upon display 320. As a part of this software process, a mapping table may be created that generates matching colors for a range of colors reproducible on display 320. Furthermore, the software may not only take into consideration a suitable output in response to input received via CMF profile modification control 325, but may also take into consideration the characteristics of display 320 when creating this mapping table. For example, the display characteristics of an LCD display is different from that of a plasma display and has to be accommodated when displaying images.

The CMF graphs indicated in FIG. 4 are merely examples for purposes of description. However, it will be understood that in place of the red, green and blue wavelengths shown in FIG. 4, in other embodiments various other wavelengths may be used instead. It will be also understood that any reference to an image not only pertains to moving images (in MPEG format for example), but static images (in JPEG format for example), as well. It will be further understood that though the description above is directed at electronic imaging systems, various embodiments of the invention may be applied against non-electronic media as well. Such media may include paper or other forms of media that may be used to reproduce or display images.

As far as electronic imaging system implementations are concerned, the methods and systems described in the present disclosure may be implemented in hardware, software, firmware or combination thereof. Features described as blocks, modules or components may be implemented together (e.g., in a logic device such as an integrated logic device) or separately (e.g., as separate connected logic devices). The software portion of the methods of the present disclosure may comprise a computer-readable storage medium which comprises instructions that, when executed, perform, at least in part, the described methods. The computer-readable medium may comprise, for example, a random access memory (RAM) and/or a read-only memory (ROM). The instructions may be executed by a processor (e.g., a microprocessor, a microcontroller, a digital signal processor (DSP), an application specific integrated circuit (ASIC), a standard logic integrated circuit, or a field programmable logic array (PLD, FPGA etc.)).

All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The examples set forth above are provided to give those of ordinary skill in the art a complete disclosure and description of how to make and use the embodiments for individualized color matching, and are not intended to limit the scope of what the inventor regards as the invention. Modifications of the above-described modes for carrying out the disclosure may be used by persons of skill in the art, and are intended to be within the scope of the following claims.

What is claimed is:

1. A method for color matching, comprising:
providing a color matching function (CMF) graph corresponding to a displayed image;
selecting at least one of a point or a parameter on the CMF graph; and
setting a new value for the at least one of a point or a parameter for obtaining a desired color preference in the displayed image.

2. The method of claim 1, wherein the desired color preference in the displayed image is based on the color characteristics of a reference image.

3. The method of claim 1, wherein the at least one of a point or a parameter is nominally centered at a first wavelength associated with the CMF graph.

4. The method of claim 3, wherein setting the new value comprises changing an amplitude of the first wavelength.

5. The method of claim 4, wherein the first wavelength corresponds to one of a red, green or blue wavelength.

6. The method of claim 5, wherein changing the amplitude of a point or a parameter on one of the red, green or blue wavelengths does not substantially affect the amplitude of another one of the red, green or blue wavelengths.

7. The method of claim 3, wherein setting the new value comprises shifting a point on the first wavelength from a first wavelength on the CMF graph to a second wavelength on the CMF graph.

8. The method of claim 7, wherein the first wavelength is approximately centered at one of a red, green or blue wavelength region.

9. The method of claim 8, wherein the second wavelength is an offset wavelength in one of the red, green or blue wavelength regions.

10. The method of claim 1, further comprising:
selecting a plurality of additional points on the CMF graph; and
setting new values for the plurality of additional points.

11. The method of claim 10, wherein the set of additional points is limited to a predetermined number of additional points.

12. The method of claim 1, wherein setting the new value for the at least one of a point or a parameter is based on viewing a reference image.

13. A system for color matching, comprising:
an image generation circuit;
a display configured to receive a signal from the image generation circuit and display therefrom an image; and
a color matching function (CMF) profile modification control communicatively coupled to the image generation circuit, the CMF profile modification control operable to vary at least one of a point or a parameter on a CMF profile for obtaining a desired color preference in the displayed image.

14. The system of claim 13, wherein the desired color preference in the displayed image is based on the color characteristics of a reference image.

15. The system of claim 13, wherein the CMF profile modification control is configured to change an amplitude of the CMF profile at a selected wavelength.

16. The system of claim 15, wherein the selected wavelength is centered at one of a red, green, or blue wavelength region.

17. The system of claim 14, wherein the CMF profile modification control is configured to shift a first wavelength in the CMF profile to a new wavelength.

18. The system of claim 18, wherein each of the first and the new wavelength is located inside one of a red, green, or blue wavelength region.

19. A non-transitory computer-readable storage medium in which is stored instructions for:
varying a magnitude parameter associated with a color matching function (CMF) graph, wherein the varying the magnitude parameter is directed at generating an image with a desired color characteristic at a first wavelength corresponding to the varied magnitude parameter.

20. The non-transitory computer-readable storage medium of claim 19, further comprising instructions for:
shifting the first wavelength to a second wavelength by varying a wavelength parameter associated with the CMF graph.

21. The non-transitory computer-readable storage medium of claim 19, wherein varying the magnitude parameter associated with the CMF graph comprises at least one of (i) varying a peak amplitude indicated by the CMF graph at the first wavelength and (ii) varying a minimum amplitude value indicated by the CMF graph at the first wavelength.

22. The non-transitory computer-readable storage medium of claim 19, wherein the CMF graph is associated with a first light source, and wherein the CMF graph is associated with a first display incorporating the first light source, and wherein varying the magnitude parameter associated with the CMF graph is based at least in part on a visual comparison of the first display with a reference display.
